(19) United States
(12) Patent Application Publication
(10) Pub. No.: US 2017/0031705 A1
(43) Pub. Date: Feb. 2, 2017

(54) METHOD AND DEVICE FOR OPERATING CHANGING GUEST SYSTEMS UNDER A HYPERVISOR

(71) Applicant: Robert Bosch GmbH, Stuttgart (DE)

(72) Inventors: Ingo Ehlert, Sachsenheim (DE); Gunnar Piel, Hemmingen (DE)

(21) Appl. No.: 15/222,132

(22) Filed: Jul. 28, 2016

(30) Foreign Application Priority Data
Jul. 29, 2015 (DE) 102015214390.2

(51) Int. Cl. G06F 9/455

(52) U.S. Cl. CPC G06F 9/45558; G06F 2009/45575

(57) ABSTRACT

A method for operating changing guest systems under a hypervisor, including, on a host system, the hypervisor monitors at least one virtual machine including a guest system. The guest system provides a prompt to the hypervisor, as a function of a system context of the host system, to switch the virtual machine from a first guest system variant to a second guest system variant. The host system carries out the switch in response to the prompt by the guest system.

### CROSS REFERENCE

The present application claims the benefit under 35 U.S.C. §119 of German Patent Application No. DE 102015214390.2 filed on Jul. 29, 2015, which is expressly incorporated herein by reference in its entirety.

### FIELD

The present invention relates to a method for operating changing guest systems under a hypervisor. The present invention moreover relates to a corresponding device, to a corresponding computer program, and to a corresponding storage medium.

### BACKGROUND INFORMATION

The related art includes so-called virtualized systems in which a hypervisor sets up multiple virtual machines in respective dedicated partitions of a shared host system. A guest system is operated in each virtual machine. Guest systems may be exchanged or updated in this environment.

German Patent Application No. DE 102012208753 A1 describes a microcomputer including a single core, which is used in a time-shared manner to provide multiple virtual cores. The core provides a core activation element and a core stopping element. The core activation element determines whether a core activation condition of each virtual core is met. The core activation element activates one of the virtual cores when the core activation condition of that particular one of the virtual cores is met. The core stopping element determines whether a core stopping condition is met by each virtual core. The core stopping element stops one of the virtual cores when the core stopping condition is met by that particular one of the virtual cores.

### SUMMARY

The present invention provides a method for operating changing guest systems under a hypervisor, a corresponding device, a corresponding computer program, and a corresponding storage medium.

One advantage of the present invention may lie in the beneficial option of operating multiple variants of guest systems on each virtual machine on systems which are highly dependent on their context. By evaluating the context, the system for this purpose decides which variant of a guest system in which virtual machine should be active. This may offer a great benefit when the operating conditions change in such a way that a guest system variant is not able or authorized to cover all use cases. Reasons for this may be due to security, energy savings, or the protection of intellectual property.

The method may be carried out by a device such as a control unit. The utility factor of the present invention may be illustrated in the present case based on the following example:

When the driver of a car equipped with the control unit is in the car and steering, he or she will require external connectivity, such as for remotely controlling doors or for accessing the Internet. However, when the driver is absent, external connectivity may be misused by third parties. In this case, it is possible to provide two guest system variants for one virtual machine with the aid of one specific embodiment of the present invention. While the one has an external connectivity, the other has no code for operating external interfaces.

According to one further aspect, an initial security check may be provided within each virtual machine. After the check was successfully completed, the variant containing the application is loaded.

### BRIEF DESCRIPTION OF THE DRAWINGS

Exemplary embodiments of the present invention are shown in the figures and are described in greater detail below.

FIG. 1 shows, by way of example, a method according to a first specific embodiment.

FIG. 2 schematically shows a control unit according to a second specific embodiment.

### DETAILED DESCRIPTION OF EXAMPLE EMBODIMENTS

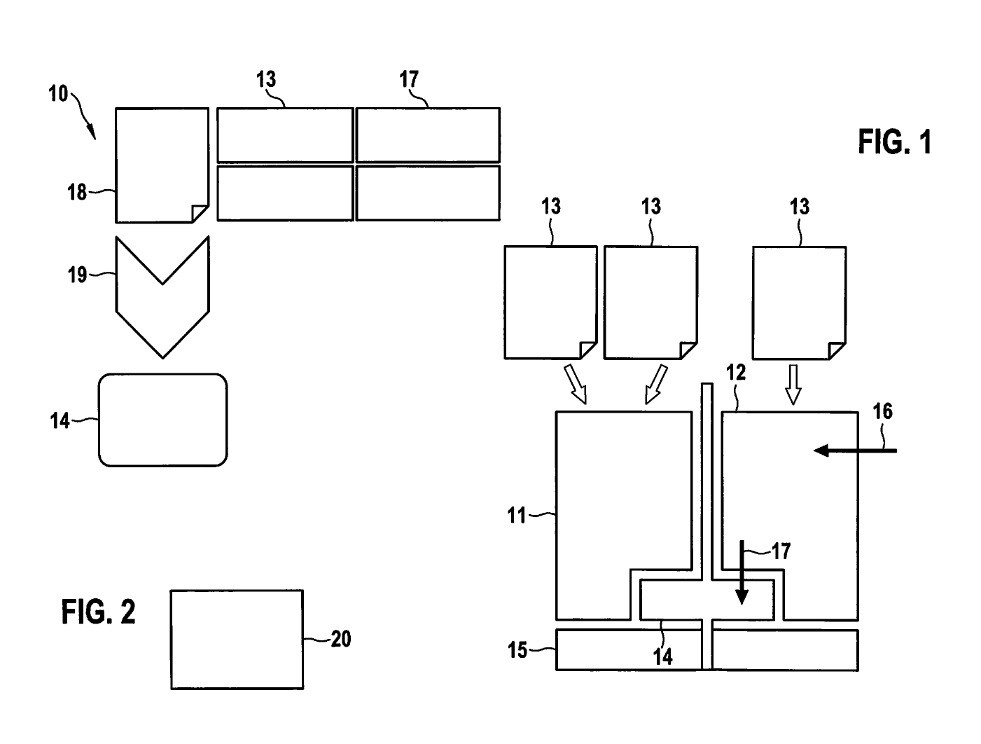

FIG. 1 illustrates the fundamental sequence of a method 10 in accordance with the present invention based on one example. It proceeds from configuration 18 of a hypervisor 14, which assigns a first guest system variant 13 having the designation “1.1” and a second guest system variant 13 having the designation “1.2” to a first virtual machine 11, and a single guest system variant 13 having the designation “2.0” to a second virtual machine 12. Configuration 18 furthermore authorizes second virtual machine 12 to provide hypervisor 14 with the prompt 17 to switch first virtual machine 11 from first guest system variant 13 to second guest system variant 13, while first virtual machine 12 is not granted a right to switch.

Based on this configuration 18, a code generation 19 of hypervisor 14 may take place within the scope of the build. After hypervisor 14 has been loaded onto host system 15, a respective image of guest system variants 13 is persistently stored on host system 15, and the latter is commissioned using the factory guest system setting.

While hypervisor 14 thus monitors first virtual machine 11 and second virtual machine 12 on host system 15, guest system variant 13 active on second virtual machine 12 in turn monitors relevant pieces of context information. If method 10 is carried out in a vehicle, considerations include, for example, the status of the vehicle, its driver, control units or pieces of sensor information. Aforementioned guest system variant 13 informs hypervisor 14 about its evaluation result and thus provides the prompt 17 to switch first virtual machine 11 from first guest system variant 13 having the designation “1.1” to second guest system variant 13 having the designation “1.2.” Second virtual machine 12 is permitted to prompt hypervisor 14 to do so since this right was granted in configuration 18 of hypervisor 14.

Finally, in response to this prompt 17, hypervisor 14 finally carries out a hot switch as a function of its configuration 18 by stopping first guest system variant 13 and starting second guest system variant 13. Alternatively, hypervisor 14 newly starts host system 15 and then starts second guest system variant 13. It shall be understood that this process takes place correspondingly when first virtual machine 11 is to be switched from active second guest system variant 13 to first guest system variant 13.

After the switch has been made, hypervisor 14 resumes monitoring of first virtual machine 11 and of second virtual machine 12.

This method 10 may be implemented in software or hardware or in a mixed form made up of software and hardware, for example in a control unit 20, as the schematic representation of FIG. 2 illustrates. In this scenario, a further use case involves an update of the firmware of control unit 20 while possibly resorting to an old or robust software version. Within the scope of such a firmware update, initially a new image for the guest system is imported, while the old image is preserved as a fallback solution. It is now decided based on a potential prior start or start attempt with the aid of which image the guest system is to be started.

What is claimed is:

1. A method for operating changing guest systems under a hypervisor, comprising:
monitoring, by the hypervisor on a host system, at least one virtual machine including a guest system;
providing a prompt to the hypervisor, by the guest system, as a function of a system context of the host system, to switch the virtual machine from a first guest system variant to a second guest system variant; and
carrying out the switch, by the host system, in response to the prompt by the guest system.

2. The method as recited in claim 1, wherein a configuration of the hypervisor assigns the guest system variants to the virtual machine.

3. The method as recited in claim 2, wherein the configuration authorizes the guest system to provide the prompt.

4. The method as recited in claim 2, wherein a code generation of the hypervisor based on the configuration is performed.

5. The method as recited in claim 1, wherein a respective image of the first guest system variant and of the second guest system variant is persistently stored on the host system.

6. The method as recited in claim 1, wherein the switch is carried out in that the hypervisor stops the first guest system variant, and loads and starts the second guest system variant.

7. The method as recited in claim 1, wherein the switch is carried out in that the hypervisor newly starts the host system and then starts the second guest system variant.

8. A machine-readable storage medium on which is stored a computer program for operating changing guest systems under a hypervisor, the computer program, when executed by a processor, causing the processor to perform:
monitoring, by the hypervisor on a host system, at least one virtual machine including a guest system;
providing a prompt to the hypervisor, by the guest system, as a function of a system context of the host system, to switch the virtual machine from a first guest system variant to a second guest system variant; and
carrying out the switch, by the host system, in response to the prompt by the guest system.

9. A device for operating changing guest systems under a hypervisor, device designed to:
monitor, by the hypervisor on a host system, at least one virtual machine including a guest system;
provide a prompt to the hypervisor, by the guest system, as a function of a system context of the host system, to switch the virtual machine from a first guest system variant to a second guest system variant; and
carry out the switch, by the host system, in response to the prompt by the guest system.
